(19) United States
(12) Patent Application Publication
(10) Pub. No.: US 2005/0265565 A1
(43) Pub. Date: Dec. 1, 2005

(54) Information processing apparatus

(75) Inventors: Mikio Sakemoto, Saitama (JP); Kenichi Agata, Tokyo (JP); Yoshitaka Narukawa, Saitama (JP); Junichiro Wachi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/133,378

(22) Filed: May 20, 2005

(30) Foreign Application Priority Data
May 26, 2004 (JP) 2004-155846

(51) Int. Cl. H02B 1/00; H04B 3/00

(52) U.S. Cl. 381/123; 381/77

(57) ABSTRACT

The present invention provides an information processing apparatus including an incorporated audio output section and a connector with a terminal section of an audio output device as an external device connected thereto, and a source of audio output is switched between the audio output section and the audio output device according to whether any audio output device is connected to the connector or not, and further a volume of sounds outputted from the audio output section or from the audio output device can be controlled.

### BACKGROUND OF THE INVENTION

The present invention relates to an information processing apparatus. More specifically, the present invention relates to an information processing apparatus having an audio output section therein by switching outputted sounds according to the condition of connection with an audio output device as an external connecting device, as well as controlling the volume of sounds, so as to improve the convenience in use of information processing apparatus.

In relation to information processing apparatuses represented by a personal computer, there have been made active efforts for development of a new type of information processing apparatus compatible with multimedia providing images and audio in association with recent progresses in the related technology, including those capable of outputting sounds from an internal speaker incorporated therein, or from an audio output device connected thereto as an external connecting device (refer to, for example, Japanese Patent Laid-open No. 2004-46729).

In the information processing apparatus based on the related-art technology as described above, sounds are outputted from the internal speaker when the audio output device is not connected, and when an audio output device is connected, an output source of sounds is switched, and then sounds are outputted from the audio output device connected thereto.

However, the related-art information processing apparatus has the problem that a user has to manually control a volume of sounds from the internal speaker or the audio output device according to his or her taste every time the audio output device is connected or removed, which is troublesome and is disadvantageously inconvenient in use thereof.

There is another inconvenience that an excessive volume of sounds may give too much stress to the user's ear in a case where, for example, a headphone or an earphone is connected as an audio output device in the condition of the maximum volume of sounds.

### SUMMARY OF THE INVENTION

An object of the present invention is to provide an information processing apparatus capable of overcoming the aforementioned problems and improving the convenience in use thereof by switching an output sound and controlling a volume of sounds.

In order to solve the problems described above, the information processing apparatus according to the present invention includes an audio output section incorporated therein; and a connector with a terminal section of an audio output device as an externally connected device connected thereto, wherein a destination for an audio output is switched between the audio output section and the audio output device according to whether the audio output device is connected to the connector and also a volume of sounds outputted from the audio output section or the audio output device is controlled.

Therefore, the information processing apparatus according to the present invention outputs volume-controlled sounds from the internal speaker when the audio output device is not connected thereto, or outputs the volume-controlled sounds from the audio output device when the audio output device is connected thereto.

Moreover, the volume of sounds outputted from the audio output section or the audio output device does not have to be controlled each time the audio output device is connected to or removed from the information processing apparatus, thus the convenience in use of the information processing apparatus can be improved especially in relation to handling of sounds.

The present invention can also prevent the problem that an excessive volume of sounds give too much stress to the user's ear in a case where, for example, a headphone or an earphone is connected thereto as an audio output device in the condition of the maximum volume of sounds.

Preferably, a type of the audio output device is detected based on a form of a terminal section of the audio output device connected to the connector, and a volume of sounds outputted from the audio output device is controlled according to the detected type of the audio output device. Therefore, the convenience in use of the information processing apparatus can further be improved in relation to handling of sounds.

Preferably, data concerning a volume of sounds in a preceding stage of output from the audio output section or the audio output device is stored, and when the sounds are outputted from the audio output section or the audio output device after the preceding stage is over, a volume of sounds outputted from the audio output section or audio output device is adjusted to the same level as that in the preceding stage by reading out the stored data. Therefore, the convenience for a user can be improved.

Preferably, a user can set a volume of sounds outputted from the audio output section or the audio output device and sounds are outputted with a volume set by the user from the audio output section or the audio output device. Therefore, the convenience in use for a user can be improved by outputting a volume of sounds according to the user's taste.

Preferably, a volume of sounds outputted from the audio output section or audio output device is controlled in response to used software. Therefore, the convenience in use for a user can be improved by controlling a volume of sounds according to a mode of use.

### BRIEF DESCRIPTION OF THE DRAWINGS

FIG. 1 shows a preferred embodiment of the present invention along with FIGS. 1 through 7, and is a perspective view showing an information processing apparatus;

FIG. 2 is a block diagram showing an example of hardware configuration in the information processing apparatus;

FIG. 3 is a perspective view showing a headphone device along with a portion of the information processing apparatus;

FIG. 4 is a perspective view showing another headphone device along with a portion of the information processing apparatus;

FIG. 5 is a chart showing conditions of volume of sounds set per audio output device, software, and user in three-dimensional matrix;

FIG. 6 is a flow chart showing procedures of changing a volume of sounds; and

FIG. 7 is a graph showing an example of changing a volume of sounds in time series.

### DETAILED DESCRIPTION OF THE PREFERRED EMBODIMENT

A preferred embodiment of the information processing apparatus according to the present invention is described hereafter with reference to the attached drawings.

The information processing apparatus according to the present invention can generally be applied to various types of information processing apparatuses such as a personal computer, a PDA (Personal Digital Assistant), a network terminal, a mobile information terminal, a workstation, a mobile phone, and others.

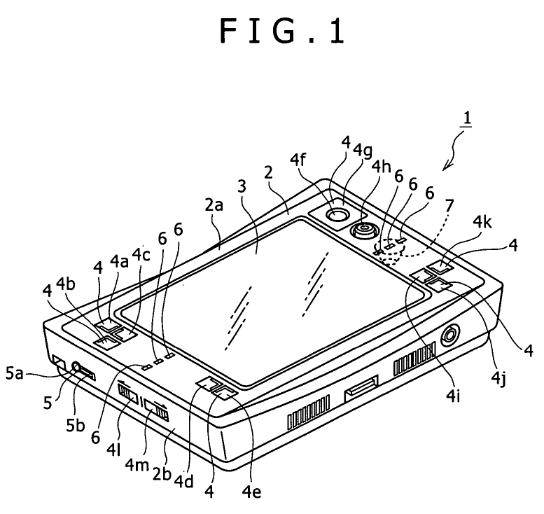

An information processing apparatus 1 includes required components provided on a housing 2 (refer to FIG. 1). The housing 2 has, for instance, a horizontally long, flat and rectangular form with a display 3 such, for example, a liquid crystal panel provided on a front surface 2a thereof.

In the information processing apparatus 1, the display 3 is a touch panel (tablet), in which various operations such as selection or input can be performed by tapping a given position of the display shown on the display 3 using a finger or a dedicated input pen (stylus) not shown in the figure.

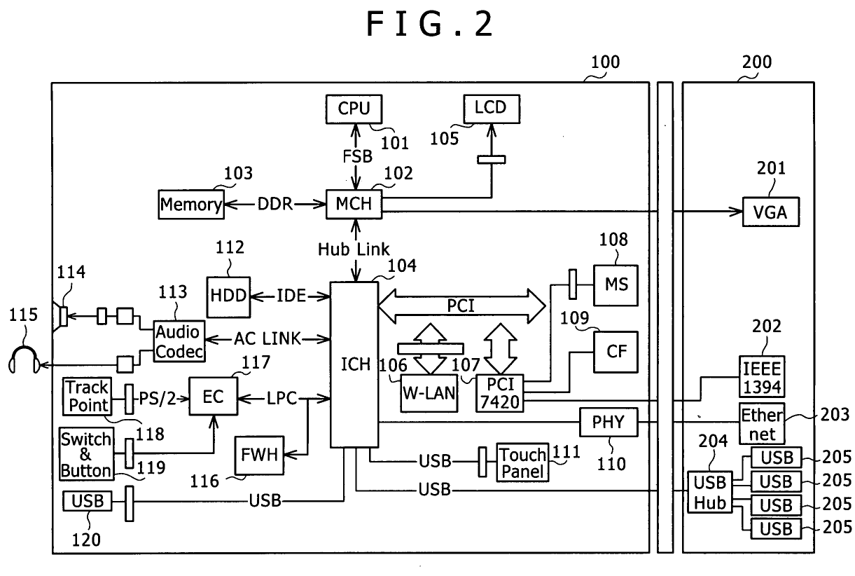

FIG. 2 shows an example of hardware configuration of the information processing apparatus including a main body section 100 and a device 200 for connection with an external device (interface device).

At first, internal configuration of the main body section 100 is described below.

A CPU 101 as a control center is connected to a controller 102 via a bus (FSB: Front Side Bus). The controller 102 is in charge of controlling a main memory 103 and graphic functions, and mainly processes a large volume of data at a high speed. The controller 102 is referred to as “north bridge” in an AT-compatible machine, to which are connected the CPU 101, the main memory 103, a controller 104, and a graphic displaying device 105 such as a liquid crystal display device (equivalent to the display 3 described above).

The controller 104 mainly controls controlling devices for user interface, and connects the devices via a bus. The controller 104 is referred to as “south bridge” in an AT-compatible machine, and plays, in “PCI to ISA bridge”, a role of bridging a bus (PCI: Peripheral Component Interconnect bus) to a low-speed bus (ISA: Industry Standard Architecture bus and the like), and also has the functions of ISA controller, IDE (Integrated Drive Electronics) controller, and the like.

The bus (PCI bus) is connected to a wireless LAN (W-LAN) as a wireless communication device 106 and to a device 107 for connecting and controlling an external memory and external devices. As the external memory, there is provided a semiconductor memory device adapted to be mounted to and removed from the main body section 100 such as, for example, a controlling device 108 for reading and writing data in a memory stick, or a controlling device 109 for controlling a memory card. Furthermore, the device 107 has a function of an interface for connection to an external device (for example, “IEEE 1394” defining specifications of hardware to add a serial device to a computer).

Connected to the controller 104 is a device 110 for LAN (Local Area Network) connection, and an input device 111 using a touch panel and the like is connected to a USB (Universal Serial Bus) port thereof.

An auxiliary memory device 112 uses a drive unit using, for example, a magnetic disk or an optical disk, and in this example, a drive unit using a large-scale memory media, such as a hard disk, is used and connected to (the IDE controller in) the controller 104.

An audio signal processing section (Audio Codec) 113 connected to the controller 104 outputs sounds by transmitting digital-analog converted audio signals to, for example, a speaker 114 or a headphone 115. Otherwise, in the device configuration provided with a microphone, the audio signal processing section 113 digitalizes the audio input data.

The memory device 116 stores therein a control program to operate the computer and the like, and is connected to controllers 104 and 117 via an LPC (Low Pin Count: serial bus) and the like.

The controller 117 is a multipurpose device to control various signals using, for example, “EC” (Embedded Controller) to control functions of a keyboard controller, power supply in the system, or additional functions of the system (a microcomputer is incorporated in a portable device). Methods of controlling the computer can be changed by changing the control program in the memory device 116.

An operation device 118 (pointing device 4h, described later) constituting a stick type pointing device (such as TrackPoint) is connected to a port in the controller 117 (such as PS/2 (Personal System/2) port). Signals from an operating section 119 provided in the main body section 100 including switches, operation button, and the like are transmitted to the controller 117.

A USB connector is provided as a connecting section 120 to connect an external device directly to the main body section 100, and the connecting section 120 is connected to the controller 117.

To the power supply section not shown in the figure, a commercial power supply voltage is applied from an AC adapter, or a direct power is applied from a battery pack using a secondary battery or a fuel cell. For example, the aforementioned EC (controller 117) detects conditions of connection or installation of the AC adapter or the battery pack, and stores various management information including a remaining life of the battery.

Next, configuration of the connecting device 200 is described.

Signals are transmitted between the main body section 100 and an external device not shown in the figure by connecting the main body section 100 to the connecting device 200 via a connecting means such as a connector.

A connector 201 to connect an external display device using a VGA (Video Graphics Array) connector is connected to the controller 102 in the main body section 100, whereby image signals are outputted to the external display device.

A connector section 202 to connect an external device compliant with “IEEE 1394” and the like is connected to the aforementioned device 107 incorporated in the main body section 100, and a connector section 203 to connect a LAN cable and the like is connected to the aforementioned device 110 incorporated in the main body section 100.

A device 204 for line concentration connected to the controller 104 in the main body section 100 uses a USB hub, and in this example, the connecting device 200 is equipped with four USB connectors 205, each USB connector 205 being connected to the device 204 for line concentration (USB hub).

Referring to FIG. 1 again, the housing 2 has a plurality of operation buttons 4 provided in given positions on the front surface 2a thereof. The operation buttons include, for example, a center button 4a, a left button 4b, a right button 4c, a zoom button 4d, a rotation button 4e, an enter button 4f, a cursor key 4g, a pointing device 4h, a function selecting button 4i, a startup button 4j, a brightness controlling button 4k, and the like.

The center button 4a, left button 4b, and right button 4c corresponds to buttons on a mouse respectively, and the zoom button 4d is used to zoom an on-screen display shown on the display 3, the rotation button 4e is used to rotate the on-screen display by 90 degrees, the enter button 4f corresponds to an enter key on a key board to implement or define an operation, the cursor key 4g is used to move a cursor shown on the display 3 vertically and horizontally and so on, the pointing device 4h is used to move a pointer shown on the display 3 and so on, the function selecting button 4i is used to change a volume of outputted sounds and switch an output to an external display, the startup button 4j is used to start up a specific software, and the brightness controlling button 4k is used to change brightness of the display 3.

There is provided a connector 5 to be connected to an audio output device as an external connecting device described hereafter at a predetermined position on a side surface 2b of the housing 2. The connector 5 includes a first connecting section 5a and a second connecting section 5b having different dimensions.

There are provided a hold switch 41 and a power supply switch 4m on the side surface 2b of the housing 2. The hold switch 41 is used to set up an operation disable mode to disable operations of the other operation buttons 4 and the power supply switch 4m is used to turn on a power supply.

There are provided output windows 6 at predetermined positions on the front surface 2a of the housing 2. There is provided an internal speaker 7 (shown as a speaker 114 on FIG. 2) functioning as an audio output section at a position corresponding to the output windows 6 in the housing 2. Sounds outputted from the internal speaker 7 is let out via the output windows 6.

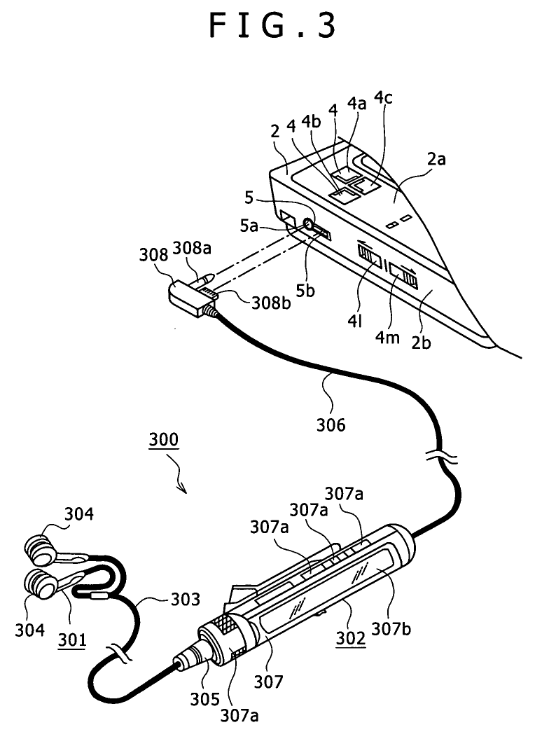

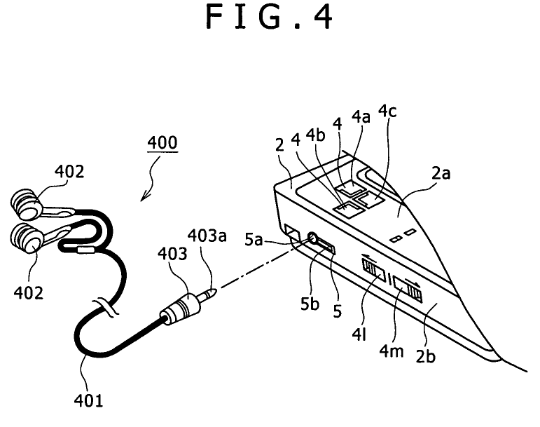

As an externally connected audio output device, for example, a headphone device 300 equipped with a remote control section (FIG. 3), a headphone device 400 without the remote control section (FIG. 4), or a speaker device not shown in the figure may be used. These audio output devices are shown as a headphone 115 in FIG. 2.

Connected to the headphone device 300 are, as shown in FIG. 3, a headphone section 301 and a remote control section 302.

The headphone section 301 includes a connection cord 303, two output sections 304 provided at an end of the connection cord 303, and a connected section 305 provided at the other end of the connection cord 303.

The remote control section 302 includes a connection cord 306, an operation display section 307 provided at an end of the connection cord 306, and a connected section 308 provided at the other end of the connection cord 306. The operation display section 307 is equipped with different types of operation tabs 307a and a display panel 307b. The connected section 305 of the headphone section 301 is connected to an end of the display panel 307b. Operating the operation tabs 307a enables, for example, to change a volume of the outputted sounds, to display information about the content being played (names of the song or the album) on the display panel 307b, to set a replay mode, and the like.

There are provided a first terminal section 308a and a second terminal section 308b having different dimensions on the connected section 308 of the remote control section 302. The first terminal section 308a has a form corresponding to the first connecting section 5a of the connector 5 provided in the information processing apparatus 1, and the second terminal section 308b has a form corresponding to the second connecting section 5b of the connector 5. Therefore, the first terminal section 308a is connected to the first connecting section 5a of the connector 5 and the second terminal section 308b is connected to the second connecting section 5b of the connector 5, thus the headphone device 300 being connected to the information processing apparatus 1.

The headphone device 400 is, as shown in FIG. 4, configured only with a section corresponding to the headphone section 301 according to the headphone device 300.

The headphone device 400 includes a connection cord 401, two output sections 402 provided at an end of the connection cord 401, and a connected section 403 provided at the other end of the connection cord 401.

The connected section 403 is provided with a terminal section 403a having a form corresponding to the first connecting section 5a of the connector 5 provided in the information processing apparatus 1. Therefore, the terminal section 403a is connected to the first connecting section 5a of the connector 5 to connect the headphone device 400 with the information processing apparatus 1.

The information processing apparatus 1 can respond to multiple users, and a plurality of users can log on the system by opening a specific log-in screen to carry out various functions respectively.

In the information processing apparatus 1, each user can set his or her own desired volume for the audio output section (internal speaker 7) or for the connected audio output devices (headphone devices 300 and 400, and the like) discretely. The volume can be set for each software to be used by the user.

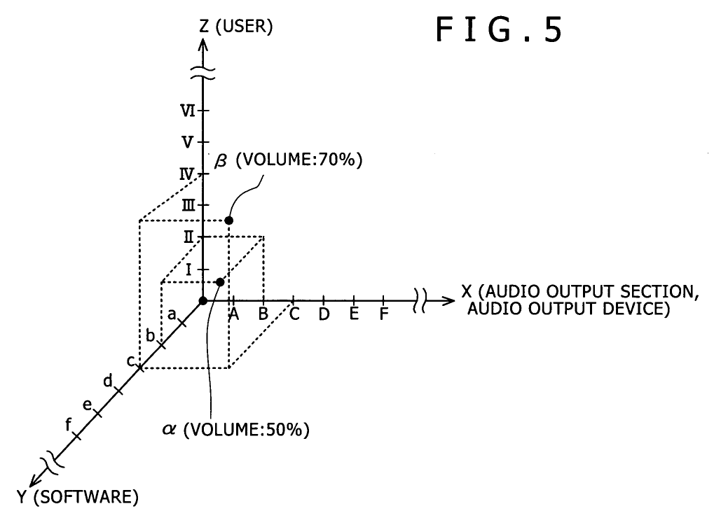

FIG. 5 shows the setup condition with a three dimensional matrix, where the axis X indicates a type of the audio output section or the audio output device (A, B, C, . . . ), axis Y indicates a type of the software (a, b, c, . . . ), and axis Z indicates a logged user (I, II, III, . . . )

For example, the case where the type of the audio output section or the audio output device is B, the type of the software is b, and the user is II corresponds to the point a shown in the figure, and a volume of output sounds is set to 50% of the maximum volume. Further the case where the type of the audio output section or the audio output device is C, the type of the software is c, and the user is IV corresponds to the point β in the figure, and in this case the output volume is set to 70% of the maximum volume.

The data regarding the volume of sounds set by each user is stored in a registry. In the condition before being set up by each user, the data of a volume of sounds presumably optimal for each audio output section, audio output device, and software is stored in the registry in advance, and the stored data is updated each time a user sets up new data.

The software includes, for example, software for reproduction of music to output sounds, software for reproduction of videos to output images as well as sounds, and the like.

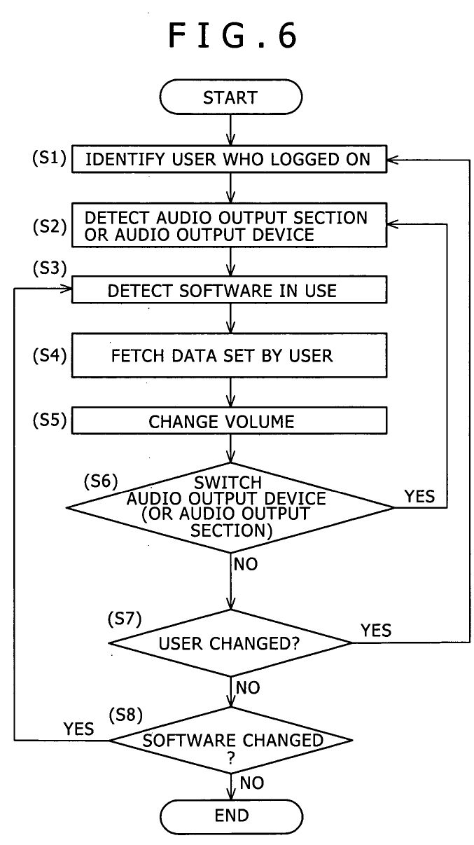

The procedure for changing a volume of sounds in the information processing apparatus 1 is described hereafter with reference to the flow chart shown in FIG. 6.

(S1) When the information processing apparatus 1 is started up, the log-in screen is displayed, and the logged user is identified by the OS (operation system).

(S2) A type of the audio output device is detected. If no audio output device is detected in this step, or if no audio output device is connected to the connector 5, it is detected that no audio output device is in connection to the information processing apparatus 1. These operations for detection are carried out by the controlling device 117 described above which functions as an EC, and the detected results are notified to a specific application for volume changing.

(S3) A type of software in use is detected. The software running on the foremost screen on the display 3 is detected as one in use.

(S4) The data set by the user and stored in the registry is fetched by the aforementioned specific application for a volume change setup. The data fetched by the application includes the data in the registry regarding the volume of sounds described by referring to FIG. 5 stored therein based on the result of identification regarding the user in step (S1), the result of detection regarding the audio output section or audio output device in step (S2), and the result of detection regarding the software in step (S3).

(S5) The volume of the sounds outputted from the audio output section or the audio output device is changed based on the data fetched in step (S4). The change of the volume is carried out based on command signals transmitted from the application to the OS.

(S6) When the audio output device or the audio output section is switched, or when the audio output device is connected to the connector 5 or the audio output device is removed from the connector 5, the system control is shifted to step (S2) and the type of the audio output section or the audio output device is detected. When the audio output device or the audio output section is not switched, the system control is shifted to step (S7).

(S7) When the logged user is changed, system control is shifted to step (S1) and user identification is executed. When the user is not changed, system control goes to step (S8).

(S8) When the software to be used is changed, system control shifts to step (S3), and detection of the type of the software is carried out. When the software to be used is not changed, the process is terminated.

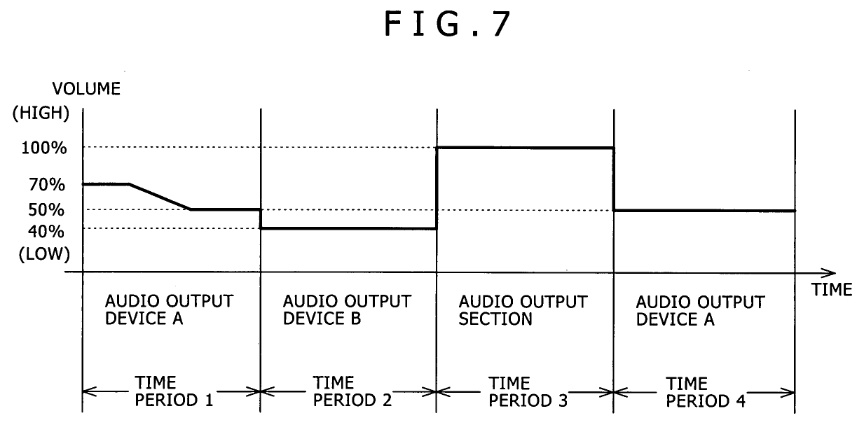

FIG. 7 shows an example of the process according to the procedure described above in a time series manner. The vertical axis indicates a volume of sounds expressed with a percentage against the maximum volume, and the horizontal axis indicates the time.

At the time period 1, the audio output device A is being used, and the volume of sounds has manually been changed from 70% to 50% by the user. The audio output device A is, for example, the headphone device 300. The manual change of the volume of sounds is carried out by operating the operation tab 307a in the remote control section 302.

During a period of time from the time period 1 to time period 2, the audio output device is switched from the audio output device A to the audio output device B. The audio output device B is, for example, the headphone device 400. At the time period 2, the audio output device B is being used, and the volume of sounds is reduced to 40% against that when the audio output device A is used.

During a period of time from the time period 2 to time period 3, the audio output device is switched from the audio output device B to the audio output section (internal speaker 7). Namely, during the period of time from the time period 2 to time period 3, the headphone device 400 is removed from the connector 5. At the time period 3, the volume of sounds is increased, to 100% of the maximum volume, comparing with the volume during use of the audio output devices A and B.

During a period from the time period 3 to time period 4, the audio output device is switched from the audio output section to the audio output device A again. This means that the headphone device 300 has been connected to the connector 5 when shifting from the time period 3 to time period 4. During this period of time, the data just before start of use of the audio output device A is fetched and sounds are outputted during this time period 4 with the same volume as that at the time period 1, and the volume is reduced, to 50%, as compared to that during use of the audio output section. Therefore, when the user connects the headphone device 300 to the connector 5 wearing the output sections 304 on both ears, the user's ears are not suffered from the overload of the high volume (maximum volume) set during use of the audio output section.

While the above-described example uses two headphone devices 300 and 400 as audio output devices in addition to the internal speaker 7 to function as an audio output section, the audio output section and the audio output devices are not limited to speakers and headphone devices but may be other devices which output sounds.

The number of the audio output devices connected to the information processing apparatus is not limited to two but may be three or more, and in this case it is necessary that each of three or more audio output devices can be set at its own volume of sounds.

Furthermore, only the connector 5 is described in the embodiment above as a part to be connected to the audio output device, other type of connector having a different form from the connector 5 and used for connection of other audio output device to the housing 2 may be provided. In this case, the audio output device connected to the connector 5 and the audio output device connected to the other connector may be detected by checking the difference in dimensions of the connector or determining a type of the audio output device implemented with the controller (EC) 117 at the time period when the audio output device is connected.

As described above, in the information processing apparatus 1, a source of audio output is switched between the internal speaker 7 and the headphone device 300 or 400 according to whether the headphone device 300 or 400 is connected to the connector 5, and also a volume of sounds outputted from the internal speaker 7 or the headphone device 300 or 400 can be changed.

Therefore, the volume of sounds outputted from the internal speaker 7 or the headphone device 300 or 400 does not have to be manually controlled each time the headphone device 300 or 400 is connected to or removed from the information processing apparatus 1, and thus the convenience in use of the information processing apparatus 1 can be improved in regard to handling sounds.

For example, when the headphone device 300 or 400 is connected in the condition of the maximum or great volume of sounds, the inconvenience that an excessive volume of sounds may give too much stress to the user's ear can be avoided because the volume of sounds is automatically controlled as the headphone device 300 or 400 is connected to the information processing apparatus 1.

Furthermore, whether a source of audio output is the headphone device 300 or the headphone 400 is detected based on dimensions of the first terminal section 308 and the second terminal section 308b of the headphone device 300, and the terminal section 403a of the headphone device 400, connected to the connector 5. According to a result of detection, a volume of sounds outputted from the headphone device 300 or 400 is changed, and thus the convenience in use of the information processing apparatus 1 can further be improved in regard to handling sounds.

Furthermore, according to the information processing apparatus 1, a volume of sounds outputted from the internal speaker 7 and the headphone device 300 or 400 can be set by each user, sounds are outputted with the set volume from each of the internal speaker 7 and the headphone device 300 or 400, and thus the convenience in use for users can be improved by outputting a volume of sounds to the user's taste.

In addition, because the volume of sounds outputted from the internal speaker 7 and the headphone device 300 or 400 is changed according to the used software, the volume can be controlled according to a mode of use, thus the convenience in use of the information processing apparatus 1 being improved.

Generally a required volume of sounds for personal hobby is different from that for presentation and the like, different volumes of sounds are required, and with the present invention, a volume of sounds are changed according to a type of software in use.

The specific dimensions and configurations of each section described above in the preferred embodiment show only one example of an embodiment to carrying out the present invention, and a technical scope of the present invention should not be construed exclusively thereby.

1. An information processing apparatus comprising:
an audio output section incorporated therein; and
a connector with a terminal section of an audio output device as an externally connected device connected thereto,
wherein a destination for an audio output is switched between the audio output section and the audio output device according to whether the audio output device is connected to said connector and also a volume of sounds outputted from the audio output section or the audio output device is controlled.

2. The information processing apparatus according to claim 1, wherein
a type of the audio output device is detected based on a form of a terminal section of the audio output device connected to said connector, and
a volume of sounds outputted from the audio output device is controlled according to the detected type of the audio output device.

3. The information processing apparatus according to claim 1, wherein
data concerning a volume of sounds in a preceding stage of output from the audio output section or the audio output device is stored, and
when the sounds are outputted from the audio output section or the audio output device after the preceding stage is over, a volume of sounds outputted from the audio output section or audio output device is adjusted to the same level as that in the preceding stage by reading out said stored data.

4. The information processing apparatus according to claim 2, wherein
data concerning a volume of sounds in a preceding stage of output from the audio output device is stored, and
when the sounds are outputted from the audio output device after the preceding stage is over, a volume of sounds outputted from the audio output device is adjusted to the same level as that in the preceding stage by reading out said stored data.

5. The information processing apparatus according to claim 1, wherein
a user can set a volume of sounds outputted from the audio output section or the audio output device and
sounds are outputted with a volume set by the user from the audio output section or the audio output device.

6. The information processing apparatus according to claim 2, wherein
a user can set a volume of sounds outputted from the audio output section or the audio output device and
sounds are outputted with a volume set by the user from the audio output section or the audio output device.

7. The information processing apparatus according to claim 1,
wherein a volume of sounds outputted from the audio output section or audio output device is controlled in response to used software.

8. The information processing apparatus according to claim 2,
wherein a volume of sounds outputted from the audio output device is controlled in response to used software.
